(19) United States
(12) Patent Application Publication
(10) Pub. No.: US 2014/0120232 A1
(43) Pub. Date: May 1, 2014

(54) ACID TASTE/ACID SMELL-REDUCING AGENT

(71) Applicants: Kenji Haraguchi, Kanagawa (JP); Yoshiko Kurobayashi, Kanagawa (JP); Yui Masuda, Kanagawa (JP)

(72) Inventors: Kenji Haraguchi, Kanagawa (JP); Yoshiko Kurobayashi, Kanagawa (JP); Yui Masuda, Kanagawa (JP)

(73) Assignee: T. HASEGAWA CO., LTD., TOKYO (JP)

(21) Appl. No.: 14/123,980

(22) PCT Filed: Jun. 4, 2012
(86) PCT No.: PCT/JP2012/064352

§ 371 Date: Dec. 5, 2013

(30) Foreign Application Priority Data
Jul. 15, 2011 (JP) 2011-156799

(51) Int. Cl. A23L 1/22

(52) U.S. Cl. CPC A23L 1/22075
USPC 426/534; 568/412

(57) ABSTRACT

Provided is an acid taste and/or acid smell-reducing agent that can effectively reduce acid taste/acid smell without adding off-taste and off-smell. The acid taste and/or acid smell-reducing agent is composed of 4,7-tridecadienal and/or 2,4,7-tridecatrienal and is added to a food or drink having acid taste and/or acid smell.

### TECHNICAL FIELD

The present invention relates to an acid taste/acid smell-reducing agent having an effect of reducing, for example, irritation or discomfort characteristic to acid taste/acid smell and relates to a food or drink containing the agent. More specifically, the invention relates to an acid taste/acid smell-reducing agent containing an unsaturated aldehyde component composed of 4,7-tridecadienal and/or 2,4,7-tridecatrienal, an acid taste/acid smell-reducing agent composition containing the agent, a food or drink containing the agent, and a method of reducing acid taste/acid smell by adding the acid taste/acid smell-reducing agent to a food or drink having the acid taste or smell.

### BACKGROUND ART

In foods and drinks, the acid taste is one of five basic tastes including sweet, salty, bitter, and umami (flavor) tastes and is a significantly important element for constituting the entire taste. Foods having an acid taste, such as fruits, e.g., apples and oranges, and fruit juice have fresh tastes, but some foods, such as lemons, limes, and yogurt, show strong irritation of acid. In addition, some fruit juice and fruit juice-containing drinks containing citric acid, malic acid, ascorbic acid, or other acid have an extreme acid taste, and it is desired to ease the acid taste to a preferable level. Furthermore, foods and drinks containing acetic acid, such as edible vinegar, dressings, mayonnaise, and black vinegar drinks, have characteristic acid tastes and smells. Not a small number of such foods and drinks have unique irritant acid taste and smell resulting from acetic acid. The acid taste and smell are not necessarily favorable to all people, and not a small number of people dislike such irritation. Furthermore, there are many foods and drinks having acid tastes containing acidifiers. The acidifier is a food additive that is used for imparting an acid taste to a food or drink or for controlling the strength of acid (acidity). The acidifier is also used as a preserving agent, an antioxidant, or an acidity regulator of foods and drinks. In such purposes, the acid taste of the acidifier is absolutely unnecessary.

Thus, the acid taste and smell are necessary for foods and drinks, but are not necessarily controlled to desired taste and smell. Accordingly, it is believed that modification of irritating acid taste and smell to mild ones increases the palatability and provides commercial products having a high-grade sense.

Accordingly, technologies for easing the irritation by an acid taste or smell have been conventionally proposed, e.g., a method of producing edible vinegar having satisfactory flavor by adding a fatty acid ethyl ester to edible vinegar to reduce the irritant smell and acid taste (Patent Literature 1); processed vinegar for foods prepared by mixing a fermentation product of a food raw material such as grain or milk protein to edible vinegar to reduce the acid taste of the vinegar (Patent Literature 2); a method of masking an acid taste by adding a sweetening agent having a high degree of sweetness to a product having the acid taste in an amount not higher than the threshold of a sweet taste (Patent Literature 3); a method of masking an acid taste by adding sucralose to a product having acid taste (Patent Literature 4); an acid-containing seasoning having a mild acid taste by containing an edible organic acid and 3-hydroxy-4,5-dimethyl-2(5H)-furanone (Patent Literature 5); a method of providing a mild flavor by adding a soup stock or an extract of kelp to an acidic seasoning containing citrus juice and soy source to reduce the unpleasant smell and acid taste of the acidic seasoning (Patent Literature 6); a food storage modifier in a powder form prepared by mixing maltitol and/or erythritol with at least one organic acid selected from the group consisting of acetic acid, sodium acetate, and adipic acid (Patent Literature 7); a method of masking the acid taste of a food by adding sodium 5′-uridilate and/or sodium 5′-cytidylate to the food (Patent Literature 8); a method of reducing an unpleasant taste resulting from salty taste, bad smell, bitter taste, astringent taste, acid taste, etc. by adding inulin to soft drinks, vegetable beverages, or milk beverages (Patent Literature 9); and an acid taste-reducing agent containing a dried bonito extract extracted from dried bonito as an active ingredient (Patent Literature 10).

Unfortunately, the umami (flavor) components used in the technologies described in Patent Literatures 2, 6, 8, and 10 and the sweetness components used in the technologies described in Patent Literatures 3, 4, and 7 increase their own taste and thereby disadvantageously cause a change in the original taste of a food or drink containing an acid taste/acid smell-reducing agent including such a component. In the technologies described in Patent Literatures 1 and 5, the aroma components used as acid taste-reducing agents have a possibility of changing the original smell of a food or drink when they are used in the concentrations described in Patent Literatures 1 and 5. In the case of adding a polysaccharide described in Patent Literature 9 to a food or drink, the viscosity of the food or drink is increased, and the sensation of the food or drink going down the throat and texture of the food or drink may be changed.

Accordingly, it was demanded to develop an acid taste and/or acid smell-reducing agent for reducing acid taste and smell and also a food or drink having reduced acid taste and/or acid smell by containing the acid taste and/or acid smell-reducing agent without changing the original taste, smell, sensation of the food or drink going down the throat, and texture of the food or drink.

Incidentally, 2,4,7-tridecatrienal is a volatile compound having an aroma found from the flavor of cooked chicken (Non-Patent Literature 1) and also found in thermal decomposition products of arachidonic acid (Non-Patent Literature 2) and in thermal decomposition products of phospholipid (Non-Patent Literature 3) and is thus also present in nature. The use thereof as a flavor is proposed, for example, a method of providing a flavor evoking chicken (Patent Literature 11), a method of providing a flavor evoking chicken by a combination of 4-cis-decenal and 2,4,7-tridecatrienal (Patent Literature 12), and a use as a flavor for improving a dried fish flavor (Patent Literature 13).

In addition, 4,7-tridecadienal as a natural substance has been reported as a component of the external secretion from a secretory gland above the eyes of oribi (Ourebia ourebi) (Non-Patent Literature 4), and the use thereof as a flavor is proposed, for example, in a method of providing a flavor evoking chicken (Patent Literature 11), a use as the perfume of perfumery and cosmetics (Patent Literature 14), and a use as a flavor for improving a dried fish flavor (Patent Literature 13).

However, Non-Patent Literatures 1 to 4 and Patent Literatures 11 to 14 do not teach or suggest that the acid taste and/or acid smell of a food or drink can be reduced by adding a slight amount of 2,4,7-tridecatrienal or 4,7-tridecadienal to the food or drink.

### CITATION LIST

### Patent Literature

Patent Literature 1: Japanese Patent Laid-Open No. H05-137561
Patent Literature 2: Japanese Patent Laid-Open No. H07-203942
Patent Literature 3: Japanese Patent Laid-Open No. H10-215793
Patent Literature 4: Japanese Patent Laid-Open No. H10-243776
Patent Literature 5: Japanese Patent No. 3431547
Patent Literature 6: Japanese Patent Laid-Open No. 2001-78700
Patent Literature 7: Japanese Patent Laid-Open No. 2003-144115
Patent Literature 8: Japanese Patent No. 3962070
Patent Literature 9: Japanese Patent Laid-Open No. 2007-209268
Patent Literature 10: Japanese Patent Laid-Open No. 2008-278790
Patent Literature 11: Japanese Patent Publication No. S41-7822
Patent Literature 12: Japanese Patent Publication No. S54-12550
Patent Literature 13: Japanese Patent No. 4676572
Patent Literature 14: Japanese Patent Laid-Open No. S61-65814

### Non-Patent Literature

Non-Patent Literature 1: Journal of American Oil Chemists' Society, 51(8), 356-9 (1974)
Non-Patent Literature 2: Frontiers of Flavour Science, [Proceedings of the Weurman Flavour Research Symposium], 9th, Freising, Germany, Jun. 22-25, 1999 (2000)
Non-Patent Literature 3: Journal of Agricultural and Food Chemistry, (2004), 52(3), 581-586
Non-Patent Literature 4: Journal of Chemical Ecology, (1995), 21(8), 1191-1215

### SUMMARY OF INVENTION

### Technical Problem

It is an object of the present invention to provide an acid taste and/or acid smell-reducing agent that can be used in foods and drinks and can effectively reduce the acid taste and smell of a food or drink by being added to the food or drink while maintaining the sensation of the food or drink going down the throat and texture of the food or drink without causing any off-taste and off-smell.

### Solution to Problem

The present inventors have diligently studied in order to solve the foregoing problems and, as a result, have found that the acid taste or smell of a food or drink having irritant taste of acid or irritant smell of acid can be reduced while maintaining the sensation of the food or drink going down the throat and texture of the food or drink, without imparting unnecessary taste or aroma to the food or drink, by adding a slight amount of 2,4,7-tridecatrienal and/or 4,7-tridecadienal to the food or drink and have accomplished the present invention. Accordingly, the present invention provides the followings:

(a) An agent for reducing acid taste and/or acid smell of a food or drink, the agent comprising an unsaturated aldehyde represented by the following Formula (1)

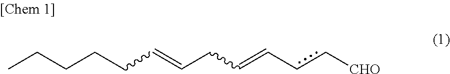

(wherein, [symbol] denotes a single bond or a double bond, and the wavy line denotes a cis or trans configuration);
(b) The agent for reducing acid taste and/or acid smell according to aspect (a), wherein the unsaturated aldehyde represented by Formula (1) is 4,7-tridecadienal;
(c) The agent for reducing acid taste and/or acid smell according to aspect (a), wherein the unsaturated aldehyde represented by Formula (1) is 2,4,7-tridecatrienal;
(d) An acid taste and/or acid smell-reducing agent composition containing 0.02 ppb to 10 ppm of an agent for reducing acid taste and/or acid smell according to any one of aspects (a) to (c);
(e) A method of reducing acid taste and/or acid smell, the method comprising adding 0.02 ppt to 10 ppb of an agent for reducing acid taste and/or acid smell according to any one of aspects (a) to (c) to a food or drink having acid taste and/or acid smell; and
(f) A food or drink having reduced acid taste and/or acid smell by containing 0.02 ppt to 10 ppb of an agent for reducing acid taste and/or acid smell according to any one of aspects (a) to (c).

The 2,4,7-tridecatrienal and 4,7-tridecadienal used in the present invention have been reported to be present in natural products and have been proposed to be used as a chicken-like flavor. However, there is no report on that they have activities of reducing acid taste and/or acid smell. Not to mention, there is absolutely no teaching or suggestion that the acid taste and/or acid smell of a food or drink having irritating taste of acid and/or irritating smell of acid can be reduced by adding a slight amount of 2,4,7-tridecatrienal or 4,7-tridecadienal to the food or drink.

In the present invention, the reduction in acid taste refers to that when a food or drink having an acid taste is put in the mouth, the acid taste sensed by the tongue decreases (or the acid taste is reduced).

As described above, the acid taste is one of five basic tastes (acid taste, sweet taste, salty taste, bitter taste, and umami (flavor) taste) and is the characteristic taste that is sensed by the acid taste receptor present in the taste bud cells of the tongue stimulated by an acid taste material (e.g., acetic acid, citric acid, malic acid, lactic acid, or tartaric acid) contained in a food or drink. Accordingly, the sensation of the acid taste is involved in only the taste sensed through the taste bud cells of the tongue and is distinguished from the acid taste as the total “taste” that is sensed as a result of interaction of various factors such as the spicy flavor, astringent taste, richness, aroma, temperature, and color.

In the present invention, whether the acid taste is reduced or not can be evaluated by a sensory test in which panels actually examine the taste with their tongues by putting a food or drink in their mouths or can be evaluated by instrumental analysis using, for example, a taste sensor that digitizes the acid taste.

In the present invention, though the mechanism of action of reducing the acid taste by 2,4,7-tridecatrienal and 4,7-tridecadienal is not fully elucidated, it is believed, for example, that these materials bind to the end of a proton ion channel that is an acid taste receptor to reduce an acid taste material from passing through the channel or that these materials react with an acid taste material to bind to a sweet taste receptor of the tongue and thereby allow the sweet taste to be antecedently sensed to mask the irritation of the acid taste.

In the present invention, the reduction in acid smell refers to that the acid smell of a food or drink decreases (or the acid smell is reduced). The acid smell is the sour smell caused by lower fatty acid, organic acid, inorganic acid, etc.

Whether the acid smell is reduced or not can be evaluated by a sensory test in which panels actually examine the acid smell with their noses or can be evaluated with an odor sensor that digitizes the acid smell.

In the present invention, though the mechanism of action of reducing the acid smell by 2,4,7-tridecatrienal and 4,7-tridecadienal is not fully elucidated, but it is believed, for example, that these materials bind to a smell receptor involved in the acid smell to reduce the activity thereof or that these materials mask the acid smell.

### Advantageous Effects of Invention

The acid taste and/or acid smell-reducing agent of the present invention and an agent composition containing the acid taste and/or acid smell-reducing agent can reduce the acid taste or smell while maintaining the sensation of the food or drink going down the throat and texture of a food or drink having the acid taste or smell, without imparting unnecessary taste or aroma to the food or drink. Note that the food or drink having an acid taste or smell refers to not only a food or drink originally having the acid taste or acid smell but also a food or drink imparted with the acid taste or smell by containing another component (e.g., acidifier).

### DESCRIPTION OF EMBODIMENTS

2,4,7-Tridecatrienal, one of the unsaturated aldehydes used in the present invention, has four geometric isomers ((E,Z,Z), (E,E,Z), (E,Z,E), and (E,E,E)), and (E,Z,Z)-2,4,7-tridecatrienal, which has been found in nature as described in Non-Patent Literatures 1 to 3, etc., is most preferred from the point of an effect of reducing acid taste and smell.

4,7-Tridecadienal that is used in the present invention has four geometric isomers ((Z,Z), (E,Z), (Z,E), and (E,E)), and (Z,Z)-4,7-tridecadienal is most preferred from the point of an effect of reducing acid taste and smell.

(E,Z,Z)-2,4,7-Tridecatrienal can be synthesized by a known method, for example, by bromination of 2-octyn-1-ol as a starting material, coupling using a Grignard derivative of (E)-2-penten-4-yn-1-ol and a copper catalyst, partial hydrogenation using a Lindlar catalyst, and oxidation by manganese dioxide (J. Agric. Food Chem. 2001, 49, 2959-2965). Other geometric isomers of 2,4,7-tridecatrienal can be obtained by separation from a mixture of 2,4,7-tridecatrienal isomers by utilizing the differences in physical properties or chemical properties, isomerization using an appropriate catalyst, or synthesis by a method described in Japanese Patent Application No. 2011-042255, which has been filed by the present applicant before.

(Z,Z)-4,7-Tridecadienal, one of the unsaturated aldehydes used in the present invention, can also be synthesized by a known method, for example, by the method described in Non-Patent Literature 4. In an example, 2-octyn-1-ol is brominated by partial hydrogenation with a Lindlar catalyst to obtain Z-1-bromo-2-octene. Separately, 5-tetrahydropyranyloxypropanyl-1-pentyne is prepared by reaction of 1-bromo-3-tetrahydropyranyloxypropane and sodium acetylide in the presence of ammonia. The resulting 5-tetrahydropyranyloxypropanyl-1-pentyne is converted into a Grignard derivative thereof, which is coupled with the 1-bromo-2-octene prepared above in the presence of copper chloride to obtain 1-tetrahydropyranyloxy-7-tridecen-1-yne. Subsequently, after partial hydrogenation with a Lindlar catalyst, the tetrahydropyranyl group as the protective group is removed, and the resulting hydroxy group is oxidized to obtain (Z,Z)-4,7-tridecadienal. Other geometric isomers of 4,7-tridecadienal can be obtained by separation from a mixture of 4,7-tridecadienal isomers by utilizing the differences in physical properties or chemical properties, isomerization using an appropriate catalyst, or synthesis by a method described in Japanese Patent Application No. 2011-042255, which has been filed by the present applicant before.

The amount of the acid taste and/or acid smell-reducing agent used in the present invention is usually 0.02 ppt to 10 ppb based on the amount of the food or drink to which the agent is added. More specifically, though it varies depending on the type of the geometric isomer of 2,4,7-tridecatrienal or 4,7-tridecadienal and the type of the food or drink, in a case using both (E,Z,Z)-2,4,7-tridecatrienal and (Z,Z)-4,7-tridecadienal as the acid taste and/or acid smell-reducing agent, the total amount of both ranges, for example, from 0.02 ppt to 10 ppb, preferably from 0.1 ppt to 500 ppt, and more preferably from 0.5 ppt to 20 ppt, based on the amount of the food or drink having acid taste and/or acid smell.

In cases using other geometric isomers, i.e., (E,E,Z)-, (E,Z,E)-, or (E,E,E)-2,4,7-tridecatrienal or (E,Z)-, (Z,E)-, or (E,E)-4,7-tridecadienal as the acid taste and/or acid smell-reducing agent, the total amount thereof ranges, for example, from 0.2 ppt to 10 ppb, preferably from 1 ppt to 1 ppb, and more preferably from 5 ppt to 100 ppt, based on the amount of the food or drink having acid taste and/or acid smell.

Within the mixing ratio ranges mentioned above, the agent can ease the irritation of the acid taste or smell of a food or drink to make the acid taste or smell of the food or drink mild.

If the amount of the acid taste and/or acid smell-reducing agent of the present invention is higher than 10 ppb based on the amount of the food or drink, the aromas of these aldehydes may be imparted to a food or drink. When such aromas are unnecessary for the food or drink, it is preferable that the amount of the agent be less than 10 ppb. When these aromas of the aldehydes do not cause any problem in a food or drink or preferably affect a food or drink, the amount of the agent in the food or drink may exceed 10 ppb.

If the amount of the acid taste and/or acid smell-reducing agent of the present invention is less than 0.02 ppt based on the amount of a food or drink, the effect of reducing acid taste and/or acid smell may be insufficient. When the acid taste and/or acid smell-reducing agent of the present invention is composed of only geometric isomers other than (E,Z,Z)-2,4,7-tridecatrienal and (Z,Z)-4,7-tridecadienal, if the amount of the acid taste and/or acid smell-reducing agent of the present invention is less than 0.2 ppt, the effect of reducing the acid taste and/or acid smell may be insufficient.

The unsaturated aldehydes as the acid taste and/or acid smell-reducing agent of the present invention may be directly added to a food or drink, but these unsaturated aldehydes are oil-soluble and are therefore poor in dispersibility in water, and addition of a slight amount of the agent to a food or drink is difficult from the viewpoints of measuring and diluting. Accordingly, a process of preparing an acid taste and/or acid smell-reducing agent composition containing slight amount of such an unsaturated aldehyde and adding the composition to a food or drink can be employed.

Examples of the composition include solutions of the unsaturated aldehydes of the present invention dissolved in water-miscible solvents, emulsifying preparations, and powder preparations.

Examples of the water-miscible solvent for dissolving the unsaturated aldehydes of the present invention include ethanol, methanol, acetone, tetrahydrofuran, acetonitrile, 2-methyl ethyl ketone, 2-propanol, methyl ethyl ketone, glycerin, and propylene glycol. In particular, ethanol and glycerin are particularly preferred from the viewpoint of use in foods and drinks.

The emulsifying preparation can be prepared by emulsifying the unsaturated aldehyde of the present invention with an emulsifier. The unsaturated aldehyde of the present invention may be emulsified by any method, and any emulsifier that is conventionally used for foods and drinks can be used. For example, a highly stable emulsion can be prepared by emulsification using an emulsifier, such as fatty acid monoglyceride, fatty acid diglyceride, fatty acid triglyceride, propylene glycol fatty acid ester, sucrose fatty acid ester, polyglycerine fatty acid ester, lecithin, modified starch, sorbitan fatty acid ester, quillaja extract, gum arabic, tragacanth gum, guar gum, karaya gum, xanthan gum, pectin, alginic acid or salt thereof, carrageenan, gelatin, or casein, with a homomixer, a colloid mill, a rotating disk-type homogenizer, or a high-pressure homogenizer. The amount of the emulsifier is not strictly restricted and can range over a wide range depending on the type of the emulsifier used and is usually about 0.01 to about 100 parts by weight, preferably about 0.1 to about 50 parts by weight, based on 1 part by mass of the unsaturated aldehyde of the present invention. In order to stabilize the emulsification, the water-soluble solution may be, in addition to water, a mixture of at least one of, for example, polyhydric alcohols such as glycerin, propylene glycol, sorbitol, maltitol, sucrose, glucose, trehalose, a carbohydrate solution, and reduced sugar syrup.

The thus-prepared emulsion can be optionally dried into a powder preparation. In the pulverization, the powder preparation can optionally contain an appropriate saccharide such as trehalose, dextrin, sugar, lactose, glucose, starch syrup, or reduced sugar syrup. The amount of such a saccharide can be appropriately selected depending on, for example, the characteristics required in the powder preparation.

The amount of the unsaturated aldehyde of the present invention contained in such a preparation is usually about 0.02 ppb to 10 ppm based on the amount of the preparation, in view of that the preparation is usually added to a food or drink in an amount of about 0.1% (about 0.01% to 1%), that is, in a case of (E,Z,Z)-2,4,7-tridecatrienal or (Z,Z)-4,7-tridecadienal, the amount of the unsaturated aldehyde contained in the acid taste and/or acid smell-reducing agent composition is, for example, in a range of 0.02 ppb to 10 ppm, preferably 0.1 ppb to 500 ppb, and more preferably 0.5 ppb to 20 ppb. In a case of another geometric isomer, i.e., (E,E,Z,)-, (E,Z,E)-, or (E,E,E)-2,4,7-tridecatrienal or (E,Z)-, (Z,E)-, or (E,E)-4,7-tridecadienal, the amount of the unsaturated aldehyde contained in the acid taste and/or acid smell-reducing agent composition is, for example, in a range of 0.2 ppb to 10 ppm, preferably 1 ppb to 1 ppm, and more preferably 5 ppb to 100 ppb.

The amount of the acid taste and/or acid smell-reducing agent composition of the present invention to be added to a food or drink varies depending on the type of the food or drink but is, for example, about 0.01% to 1% of the food or drink having acid taste and/or acid smell. However, the amount of the composition is preferably controlled according to the amount of the unsaturated aldehyde of the present invention contained in the composition such that the amount of the unsaturated aldehyde of the present invention contained in the food or drink is controlled within the amount described above.

The food or drink having acid taste and/or acid smell to which the acid taste and/or acid smell-reducing agent or the acid taste and/or acid smell-reducing agent composition of the present invention is added is not particularly limited, and examples thereof include edible vinegar-containing seasonings such as edible vinegar, dressing, non-oil dressing, mayonnaise, sauce, ketchup, and chili sauce; edible vinegar-containing prepared foods such as vinegared dishes and tadesu (vinegar with water pepper); edible vinegar-containing drinks such as Vermont drink made of honey and apple-cider vinegar, vinegar drinks that have been widely marketed recently, and black vinegar drinks; fruit juices, such as lemon, orange, grapefruit, kabosu, sudachi, grape, tomato, and apple, and fruit juice-containing drinks; fermented foods and drinks such as pickles, kimchi, yogurt, lactic acid bacterial beverages, and fermented milk beverages; confectioneries such as chewing gum, hard candy, gummi candy, soft candy, and tablet candy; retort pouch foods containing acidifiers, such as soups, curry roux, and Chinese foods; and ready-to-eat foods containing acidifiers, such as packed cooked rice and packed boiled noodles.

The edible vinegar in the present invention refers to edible vinegar containing acetic acid prepared by fermentation brewing or a synthetic method, such as grain vinegar, malt vinegar, rice vinegar, grape vinegar, apple-cider vinegar, and black vinegar, and a food or drink containing such edible vinegar is called an edible vinegar-containing food and drink. Among these edible vinegar-containing foods and drinks, edible vinegar-containing seasonings, such as dressing, mayonnaise, sauce, and ketchup, are foods usually containing 0.5% to 1.5% of acetic acid. The Vermont drink contains vinegar in an amount widely ranging depending on the requirements of consumers, but the amount of acetic acid contained in a Vermont drink is 0.02% to 0.5%.

Examples of the acidifier that is added to a food or drink having acid taste and/or acid smell and imparting an acid taste to the food or drink include lower fatty acids such as acetic acid, propionic acid, and butyric acid; organic acids such as adipic acid, citric acid, gluconic acid, tartaric acid, fumaric acid, monosodium fumarate, succinic acid, malic acid, and lactic acid; and inorganic acids such as phosphoric acid. These compounds have respective characteristic acid tastes. The lower fatty acids have aromas unlike other organic acids, and the irritation or discomfort of the lower fatty acids can be reduced by adding the acid taste and/or acid smell-reducing agent or the acid taste and/or acid smell-reducing agent composition to the lower fatty acids.

The present invention will now be more specifically described by examples, but is not limited to these examples.

### EXAMPLES

### Example 1

### Reduction of Acid Taste/Acid Smell of Vermont Drink by (Z,Z)-4,7-Tridecadienal

Water was added to a mixture of 10 g of apple-cider vinegar (acetic acid: 4.8%), 3 g of honey, 7 g of fructose-glucose liquid sugar mixed with sugar, 0.02 g of citric acid, 0.002 g of trisodium citrate, and 0.1 g of a Vermont flavor (manufactured by T. Hasegawa Co., Ltd.) to give a total amount of 100 mL. To the resulting mixture was added (Z,Z)-4,7-tridecadienal as the acid taste and/or acid smell-reducing agent of the present invention in concentrations shown in the following Table 1 to give Vermont drinks containing the agent.

Sensory evaluation of each drink was carried out by ten panels. The evaluation was performed by selecting any one of the following criteria: A: acid taste/acid smell are extreme and cause irritation (there is no substantial difference from the case not containing the agent), B: acid taste/acid smell are slightly strong and slightly cause irritation (the acid taste/acid smell are slightly improved compared to the case not containing the agent), C: acid taste/acid smell are slightly unpleasant (the acid taste/acid smell are highly improved compared to the case not containing the agent), N: the irritation of acid is reduced to give a mild acid taste, and X: though the acid taste is reduced, a piercing odor characteristic to aldehydes is unpleasant. The piercing aroma characteristic to aldehydes is a characteristic aroma common to every aldehyde and refers to an irritant off-smell giving an image of deteriorated oils and fats, soap, metals, Houttuynia cordata, etc. The judgment of smell was performed by comparing the effects at different concentrations of the acid taste and/or acid smell-reducing agent, and a concentration giving the highest acid taste/acid smell quality was selected. The results are shown in Table 1.

TABLE 1
Sensory evaluation of Vermont drink containing (Z,Z)-4,7-tridecadienal

| Concentration of (Z,Z)- | | | | | | | | |
|---|---|---|---|---|---|---|---|---|
| 4,7-tridecadienal | | Evaluation | | | | | Flavor | |
| (Z,Z)-4,7-Tridecadienal-free | | A | B | C | N | X | judgment | Notes |
| 0.005 | ppt | 10 | 0 | 0 | 0 | 0 | 0 | |
| 0.02 | ppt | 8 | 1 | 1 | 0 | 0 | 0 | |
| 0.1 | ppt | 6 | 2 | 2 | 0 | 0 | 0 | |
| 0.2 | ppt | 5 | 3 | 2 | 0 | 0 | 0 | |
| 0.5 | ppt | 1 | 1 | 3 | 5 | 0 | 1 | 1 |
| 1 | ppt | 0 | 1 | 3 | 6 | 0 | 2 | 2 |
| 5 | ppt | 0 | 1 | 2 | 7 | 0 | 4 | 3 |
| 20 | ppt | 0 | 0 | 3 | 6 | 1 | 3 | 4 |
| 100 | ppt | 0 | 1 | 3 | 4 | 2 | 0 | 5 |
| 500 | ppt | 0 | 2 | 2 | 4 | 2 | 0 | 6 |
| 1 | ppb | 0 | 0 | 3 | 3 | 4 | 0 | 7 |
| 10 | ppb | 0 | 1 | 2 | 2 | 5 | 0 | 8 |
| 50 | ppb | 0 | 0 | 1 | 2 | 7 | 0 | 9 |

Evaluation
A: the number of panels who felt such that the acid taste/acid smell are extreme and cause irritation (there is no substantial difference from the case not containing the agent),
B: the number of panels who felt such that the acid taste/acid smell are slightly strong and slightly cause irritation (the acid taste/acid smell are slightly improved compared to the case not containing the agent),
C: the number of panels who felt such that the acid taste/acid smell are slightly unpleasant (the acid taste/acid smell are highly improved compared to the case not containing the agent),
N: the number of panels who felt such that the irritation of acid is reduced to give a mild acid taste,
X: the number of panels who felt such that though the acid taste is reduced, a piercing odor characteristic to aldehydes is unpleasant, and
Flavor judgment: the number of panels who judged that the acid taste/acid smell quality is the highest (comparison between concentrations).
1~4: Acid taste and smell are mild, and irritation is not particularly felt.
5: A piercing odor characteristic to aldehydes is very slightly felt.
6: A piercing odor characteristic to aldehydes is slightly felt.
7: A piercing odor characteristic to aldehydes is somewhat felt.
8: A piercing odor characteristic to aldehydes is moderately felt.
9: A piercing odor characteristic to aldehydes is somewhat strongly felt.

As shown in Table 1, though (Z,Z)-4,7-tridecadienal-free Vermont drink had extreme acid taste/acid smell to cause irritation, in the Vermont drink containing 0.02 ppt to 10 ppb of (Z,Z)-4,7-tridecadienal, an effect of reducing the acid taste/acid smell was observed, and the odor characteristic to (Z,Z)-4,7-tridecadienal was not so strong. The concentration range of the (Z,Z)-4,7-tridecadienal that relatively satisfactorily reduces the acid taste/acid smell and hardly causes the odor characteristic to (Z,Z)-4,7-tridecadienal was 0.1 ppt to 500 ppt. Furthermore, in a range of 0.5 ppt to 20 ppt, the odor characteristic to (Z,Z)-4,7-tridecadienal was not felt at all, and the evaluation of most panels was that the irritation of acid was reduced to give a mild acid taste.

### Example 2

### Reduction of Acid Taste/Acid Smell of Vermont Drink by (E,Z,Z)-2,4,7-Tridecatrienal

A drink was prepared as in Example 1 except that (E,Z,Z)-2,4,7-tridecatrienal was used instead of (Z,Z)-4,7-tridecadienal in Example 1 and was subjected to the same sensory evaluation. The results are shown in Table 2.

TABLE 2
Sensory evaluation of Vermont drink containing
(E,Z,Z)-2,4,7-tridecatrienal

| Concentration of | | | | | | | | |
|---|---|---|---|---|---|---|---|---|
| (E,Z,Z)-2,4,7-tridecatrienal | | | | | | | | |
| (E,Z,Z)-2,4,7- | | Evaluation | | | | | Flavor | |
| Tridecatrienal-free | | A | B | C | N | X | judgment | Notes |
| 0.005 | ppt | 10 | 0 | 0 | 0 | 0 | 0 | |
| 0.02 | ppt | 8 | 1 | 1 | 0 | 0 | 0 | |
| 0.1 | ppt | 7 | 2 | 1 | 0 | 0 | 0 | |
| 0.2 | ppt | 4 | 3 | 3 | 0 | 0 | 0 | |
| 0.5 | ppt | 0 | 1 | 3 | 6 | 0 | 1 | 1 |
| 1 | ppt | 0 | 1 | 2 | 7 | 0 | 3 | 2 |
| 5 | ppt | 0 | 0 | 3 | 7 | 0 | 3 | 3 |
| 20 | ppt | 0 | 0 | 4 | 6 | 0 | 3 | 4 |
| 100 | ppt | 0 | 2 | 3 | 4 | 1 | 0 | 5 |
| 500 | ppt | 0 | 0 | 3 | 4 | 3 | 0 | 6 |
| 1 | ppb | 0 | 0 | 3 | 3 | 4 | 0 | 7 |
| 10 | ppb | 0 | 0 | 2 | 3 | 5 | 0 | 8 |
| 50 | ppb | 0 | 0 | 1 | 2 | 7 | 0 | 9 |

Evaluation
A: the number of panels who felt such that the acid taste/acid smell are extreme and cause irritation (there is no substantial difference from the case not containing the agent),
B: the number of panels who felt such that the acid taste/acid smell are slightly strong and slightly cause irritation (the acid taste/acid smell are slightly improved compared to the case not containing the agent),
C: the number of panels who felt such that the acid taste/acid smell are slightly unpleasant (the acid taste/acid smell are highly improved compared to the case not containing the agent),
N: the number of panels who felt such that the irritation of acid is reduced to give a mild acid taste,
X: the number of panels who felt such that though the acid taste is reduced, a piercing odor characteristic to aldehydes is unpleasant, and
Flavor judgment: the number of panels who judged that the acid taste/acid smell quality is the highest (comparison between concentrations).
1~4: Acid taste and smell are mild, and irritation is not particularly felt.
5: A piercing odor characteristic to aldehydes is very slightly felt.
6: A piercing odor characteristic to aldehydes is slightly felt.
7: A piercing odor characteristic to aldehydes is somewhat felt.
8: A piercing odor characteristic to aldehydes is moderately felt.
9: A piercing odor characteristic to aldehydes is somewhat strongly felt.

As shown in Table 2, though (E,Z,Z)-2,4,7-tridecatrienal-free Vermont drink had extreme acid taste/acid smell to cause irritation, in the Vermont drink containing 0.02 ppt to 10 ppb of (E,Z,Z)-2,4,7-tridecatrienal, an effect of reducing the acid taste/acid smell was observed, and the odor characteristic to (E,Z,Z)-2,4,7-tridecatrienal was not so strong. The concentration range of the (E,Z,Z)-2,4,7-tridecatrienal that relatively satisfactorily reduces the acid taste/acid smell and hardly causes the odor characteristic to (E,Z,Z)-2,4,7-tridecatrienal was 0.1 ppt to 500 ppt. Furthermore, in a range of 0.5 ppt to 20 ppt, the odor characteristic to (E,Z,Z)-2,4,7-tridecatrienal was not felt at all, and the evaluation of most panels was that the irritation of acid was reduced to give a mild acid taste.

### Example 3

### Reduction of Acid Taste/Acid Smell of Vermont Drink by (E,Z)-4,7-Tridecadienal

A drink was prepared as in Example 1 except that (E,Z)-4,7-tridecadienal was used instead of (Z,Z)-4,7-tridecadienal in Example 1 and was subjected to the same sensory evaluation. The results are shown in Table 3.

TABLE 3
Sensory evaluation of Vermont drink containing (E,Z)-4,7-tridecadienal

| Concentration of | | | | | | | | |
|---|---|---|---|---|---|---|---|---|
| (E,Z)-4,7-tridecadienal | | Evaluation | | | | | Flavor | |
| (E,Z)-4,7-tridecadienal-free | | A | B | C | N | X | judgment | Notes |
| 0.005 | ppt | 10 | 0 | 0 | 0 | 0 | 0 | |
| 0.02 | ppt | 10 | 0 | 0 | 0 | 0 | 0 | |
| 0.1 | ppt | 10 | 0 | 0 | 0 | 0 | 0 | |
| 0.2 | ppt | 8 | 2 | 0 | 0 | 0 | 0 | |
| 0.5 | ppt | 6 | 3 | 1 | 0 | 0 | 0 | |
| 1 | ppt | 0 | 4 | 5 | 1 | 0 | 0 | |
| 5 | ppt | 0 | 1 | 3 | 6 | 0 | 4 | 1 |
| 20 | ppt | 0 | 0 | 2 | 8 | 0 | 3 | 2 |
| 100 | ppt | 0 | 1 | 2 | 7 | 0 | 3 | 3 |
| 500 | ppt | 0 | 1 | 3 | 4 | 2 | 0 | 4 |
| 1 | ppb | 0 | 0 | 2 | 4 | 4 | 0 | 5 |
| 10 | ppb | 0 | 0 | 2 | 4 | 4 | 0 | 6 |
| 50 | ppb | 0 | 0 | 0 | 2 | 8 | 0 | 7 |

Evaluation
A: the number of panels who felt such that the acid taste/acid smell are extreme and cause irritation (there is no substantial difference from the case not containing the agent),
B: the number of panels who felt such that the acid taste/acid smell are slightly strong and slightly cause irritation (the acid taste/acid smell are slightly improved compared to the case not containing the agent),
C: the number of panels who felt such that the acid taste/acid smell are slightly unpleasant (the acid taste/acid smell are highly improved compared to the case not containing the agent),
N: the number of panels who felt such that the irritation of acid is reduced to give a mild acid taste,
X: the number of panels who felt such that though the acid taste is reduced, a piercing odor characteristic to aldehydes is unpleasant, and
Flavor judgment: the number of panels who judged that the acid taste/acid smell quality is the highest (comparison between concentrations).
1~3: Acid taste and smell are mild, and irritation is not particularly felt.
4: A piercing odor characteristic to aldehydes is very slightly felt.
5: A piercing odor characteristic to aldehydes is somewhat felt.
6: A piercing odor characteristic to aldehydes is moderately felt.
7: A piercing odor characteristic to aldehydes is somewhat strongly felt.

As shown in Table 3, though (E,Z)-4,7-tridecadienal-free Vermont drink had extreme acid taste/acid smell to cause irritation, in the Vermont drink containing 0.2 ppt to 10 ppb of (E,Z)-4,7-tridecadienal, an effect of reducing the acid taste/acid smell was observed, and the odor characteristic to (E,Z)-4,7-tridecadienal was not so strong. The concentration range of the (E,Z)-4,7-tridecadienal that relatively satisfactorily reduces the acid taste/acid smell and hardly causes the odor characteristic to (E,Z)-4,7-tridecadienal was 1 ppt to 1 ppb. Furthermore, in a range of 5 ppt to 100 ppt, the odor characteristic to (E,Z)-4,7-tridecadienal was not felt at all, and the evaluation of most panels was that the irritation of acid was reduced to give a mild acid taste.

### Example 4

### Reduction of Acid Taste/Acid Smell of Vermont Drink by (Z,E)-4,7-Tridecadienal

A drink was prepared as in Example 1 except that (Z,E)-4,7-tridecadienal was used instead of (Z,Z)-4,7-tridecadienal in Example 1 and was subjected to the same sensory evaluation. The results are shown in Table 4.

TABLE 4
Sensory evaluation of Vermont drink containing (Z,E)-4,7-tridecadienal

| Concentration of (Z,E)- | | | | | | | | |
|---|---|---|---|---|---|---|---|---|
| 4,7-tridecadienal | | Evaluation | | | | | Flavor | |
| (Z,E)-4,7-tridecadienal-free | | A | B | C | N | X | judgment | Notes |
| 0.005 | ppt | 10 | 0 | 0 | 0 | 0 | 0 | |
| 0.02 | ppt | 10 | 0 | 0 | 0 | 0 | 0 | |
| 0.1 | ppt | 10 | 0 | 0 | 0 | 0 | 0 | |
| 0.2 | ppt | 9 | 1 | 0 | 0 | 0 | 0 | |
| 0.5 | ppt | 5 | 3 | 2 | 0 | 0 | 0 | |
| 1 | ppt | 0 | 3 | 6 | 1 | 0 | 0 | |
| 5 | ppt | 0 | 2 | 2 | 6 | 0 | 4 | 1 |
| 20 | ppt | 0 | 1 | 2 | 7 | 0 | 3 | 2 |
| 100 | ppt | 0 | 0 | 2 | 8 | 0 | 3 | 3 |
| 500 | ppt | 0 | 1 | 3 | 4 | 2 | 0 | 4 |
| 1 | ppb | 0 | 0 | 2 | 4 | 4 | 0 | 5 |
| 10 | ppb | 0 | 0 | 2 | 3 | 5 | 0 | 6 |
| 50 | ppb | 0 | 0 | 0 | 2 | 8 | 0 | 7 |

Evaluation
A: the number of panels who felt such that the acid taste/acid smell are extreme and cause irritation (there is no substantial difference from the case not containing the agent),
B: the number of panels who felt such that the acid taste/acid smell are slightly strong and slightly cause irritation (the acid taste/acid smell are slightly improved compared to the case not containing the agent),
C: the number of panels who felt such that the acid taste/acid smell are slightly unpleasant (the acid taste/acid smell are highly improved compared to the case not containing the agent),
N: the number of panels who felt such that the irritation of acid is reduced to give a mild acid taste,
X: the number of panels who felt such that though the acid taste is reduced, a piercing odor characteristic to aldehydes is unpleasant, and
Flavor judgment: the number of panels who judged that the acid taste/acid smell quality is the highest (comparison between concentrations).
1~3: Acid taste and smell are mild, and irritation is not particularly felt.
4: A piercing odor characteristic to aldehydes is very slightly felt.
5: A piercing odor characteristic to aldehydes is somewhat felt.
6: A piercing odor characteristic to aldehydes is moderately felt.
7: A piercing odor characteristic to aldehydes is somewhat strongly felt.

As shown in Table 4, though (Z,E)-4,7-tridecadienal-free Vermont drink had extreme acid taste/acid smell to cause irritation, in the Vermont drink containing 0.2 ppt to 10 ppb of (Z,E)-4,7-tridecadienal, an effect of reducing the acid taste/acid smell was observed, and the odor characteristic to (Z,E)-4,7-tridecadienal was not so strong. The concentration range of the (Z,E)-4,7-tridecadienal that relatively satisfactorily reduces the acid taste/acid smell and hardly causes the odor characteristic to (Z,E)-4,7-tridecadienal was 1 ppt to 10 ppb. Furthermore, in a range of 5 ppt to 100 ppt, the odor characteristic to (Z,E)-4,7-tridecadienal was not felt at all, and the evaluation of most panels was that the irritation of acid was reduced to give a mild acid taste.

### Example 5

### Reduction of Acid Taste/Acid Smell of Vermont Drink by (E,E)-4,7-Tridecadienal

A drink was prepared as in Example 1 except that (E,E)-4,7-tridecadienal was used instead of (Z,Z)-4,7-tridecadienal in Example 1 and was subjected to the same sensory evaluation. The results are shown in Table 5.

TABLE 5
Sensory evaluation of Vermont drink containing (E,E)-4,7-tridecadienal

| Concentration of | | | | | | | | |
|---|---|---|---|---|---|---|---|---|
| (E,E)-4,7-tridecadienal | | Evaluation | | | | | Flavor | |
| (E,E)-4,7-tridecadienal-free | | A | B | C | N | X | judgment | Notes |
| 0.005 | ppt | 10 | 0 | 0 | 0 | 0 | 0 | |
| 0.02 | ppt | 10 | 0 | 0 | 0 | 0 | 0 | |
| 0.1 | ppt | 10 | 0 | 0 | 0 | 0 | 0 | |
| 0.2 | ppt | 8 | 2 | 0 | 0 | 0 | 0 | |
| 0.5 | ppt | 6 | 2 | 2 | 0 | 0 | 0 | |
| 1 | ppt | 0 | 4 | 5 | 1 | 0 | 0 | |
| 5 | ppt | 0 | 1 | 3 | 6 | 0 | 4 | 1 |
| 20 | ppt | 0 | 0 | 3 | 7 | 0 | 3 | 2 |
| 100 | ppt | 0 | 0 | 3 | 7 | 0 | 3 | 3 |
| 500 | ppt | 0 | 2 | 3 | 3 | 2 | 0 | 4 |
| 1 | ppb | 0 | 0 | 3 | 4 | 3 | 0 | 5 |
| 10 | ppb | 0 | 0 | 1 | 3 | 6 | 0 | 6 |
| 50 | ppb | 0 | 0 | 0 | 3 | 7 | 0 | 7 |

Evaluation
A: the number of panels who felt such that the acid taste/acid smell are extreme and cause irritation (there is no substantial difference from the case not containing the agent),
B: the number of panels who felt such that the acid taste/acid smell are slightly strong and slightly cause irritation (the acid taste/acid smell are slightly improved compared to the case not containing the agent),
C: the number of panels who felt such that the acid taste/acid smell are slightly unpleasant (the acid taste/acid smell are highly improved compared to the case not containing the agent),
N: the number of panels who felt such that the irritation of acid is reduced to give a mild acid taste,
X: the number of panels who felt such that though the acid taste is reduced, a piercing odor characteristic to aldehydes is unpleasant, and
Flavor judgment: the number of panels who judged that the acid taste/acid smell quality is the highest (comparison between concentrations).
1~3: Acid taste and smell are mild, and irritation is not particularly felt.
4: A piercing odor characteristic to aldehydes is very slightly felt.
5: A piercing odor characteristic to aldehydes is somewhat felt.
6: A piercing odor characteristic to aldehydes is moderately felt.
7: A piercing odor characteristic to aldehydes is somewhat strongly felt.

As shown in Table 5, though (E,E)-4,7-tridecadienal-free Vermont drink had extreme acid taste/acid smell to cause irritation, in the Vermont drink containing 0.2 ppt to 10 ppb of (E,E)-4,7-tridecadienal, an effect of reducing the acid taste/acid smell was observed, and the odor characteristic to (E,E)-4,7-tridecadienal was not so strong. The concentration range of the (E,E)-4,7-tridecadienal that relatively satisfactorily reduces the acid taste/acid smell and hardly causes the odor characteristic to (E,E)-4,7-tridecadienal was 1 ppt to 1 ppb. Furthermore, in a range of 5 ppt to 100 ppt, the odor characteristic to (E,E)-4,7-tridecadienal was not felt at all, and the evaluation of most panels was that the irritation of acid was reduced to give a mild acid taste.

### Example 6

### Reduction of Acid Taste/Acid Smell of Vermont Drink by (E,E,Z)-2,4,7-Tridecatrienal

A drink was prepared as in Example 1 except that (E,E,Z)-2,4,7-tridecatrienal was used instead of (Z,Z)-4,7-tridecadienal in Example 1 and was subjected to the same sensory evaluation. The results are shown in Table 6.

TABLE 6
Sensory evaluation of Vermont drink containing
(E,E,Z)-2,4,7-tridecatrienal

| Concentration of (E,E,Z)- | | | | | | | | |
|---|---|---|---|---|---|---|---|---|
| 2,4,7-tridecatrienal | | Evaluation | | | | | Flavor | |
| (E,E,Z)7-tridecatrienal-free | | A | B | C | N | X | judgment | Notes |
| 0.005 | ppt | 10 | 0 | 0 | 0 | 0 | 0 | |
| 0.02 | ppt | 10 | 0 | 0 | 0 | 0 | 0 | |
| 0.1 | ppt | 10 | 0 | 0 | 0 | 0 | 0 | |
| 0.2 | ppt | 8 | 2 | 0 | 0 | 0 | 0 | |
| 0.5 | ppt | 7 | 2 | 1 | 0 | 0 | 0 | |
| 1 | ppt | 0 | 5 | 4 | 1 | 0 | 0 | |
| 5 | ppt | 0 | 2 | 3 | 5 | 0 | 3 | 1 |
| 20 | ppt | 0 | 0 | 4 | 6 | 0 | 4 | 2 |
| 100 | ppt | 0 | 0 | 3 | 7 | 0 | 3 | 3 |
| 500 | ppt | 0 | 0 | 4 | 4 | 2 | 0 | 4 |
| 1 | ppb | 0 | 0 | 3 | 4 | 3 | 0 | 5 |
| 10 | ppb | 0 | 0 | 2 | 2 | 6 | 0 | 6 |
| 50 | ppb | 0 | 0 | 0 | 2 | 8 | 0 | 7 |

Evaluation
A: the number of panels who felt such that the acid taste/acid smell are extreme and cause irritation (there is no substantial difference from the case not containing the agent),
B: the number of panels who felt such that the acid taste/acid smell are slightly strong and slightly cause irritation (the acid taste/acid smell are slightly improved compared to the case not containing the agent),
C: the number of panels who felt such that the acid taste/acid smell are slightly unpleasant (the acid taste/acid smell are highly improved compared to the case not containing the agent),
N: the number of panels who felt such that the irritation of acid is reduced to give a mild acid taste,
X: the number of panels who felt such that though the acid taste is reduced, a piercing odor characteristic to aldehydes is unpleasant, and
Flavor judgment: the number of panels who judged that the acid taste/acid smell quality is the highest (comparison between concentrations).
1~3: Acid taste and smell are mild, and irritation is not particularly felt.
4: A piercing odor characteristic to aldehydes is very slightly felt.
5: A piercing odor characteristic to aldehydes is somewhat felt.
6: A piercing odor characteristic to aldehydes is moderately felt.
7: A piercing odor characteristic to aldehydes is somewhat strongly felt.

As shown in Table 6, though (E,E,Z)-2,4,7-tridecatrienal-free Vermont drink had extreme acid taste/acid smell to cause irritation, in the Vermont drink containing 0.2 ppt to 10 ppb of (E,E,Z)-2,4,7-tridecatrienal, an effect of reducing the acid taste/acid smell was observed, and the odor characteristic to (E,E,Z)-2,4,7-tridecatrienal was not so strong. The concentration range of the (E,E,Z)-2,4,7-tridecatrienal that relatively satisfactorily reduces the acid taste/acid smell and hardly causes the odor characteristic to (E,E,Z)-2,4,7-tridecatrienal was 1 ppt to 1 ppb. Furthermore, in a range of 5 ppt to 100 ppt, the odor characteristic to (E,E,Z)-2,4,7-tridecatrienal was not felt at all, and the evaluation of most panels was that the irritation of acid was reduced to give a mild acid taste.

### Example 7

### Reduction of Acid Taste/Acid Smell of Vermont Drink by (E,Z,E)-2,4,7-Tridecatrienal

A drink was prepared as in Example 1 except that (E,Z,E)-2,4,7-tridecatrienal was used instead of (Z,Z)-4,7-tridecadienal in Example 1 and was subjected to the same sensory evaluation. The results are shown in Table 7.

TABLE 7
Sensory evaluation of Vermont drink containing
(E,Z,E)-2,4,7-tridecatrienal

| Concentration of (E,Z,E)- | | | | | | | | |
|---|---|---|---|---|---|---|---|---|
| 2,4,7-tridecatrienal | | | | | | | | |
| (E,Z,E)-2,4,7- | | Evaluation | | | | | Flavor | |
| tridecatrienal-free | | A | B | C | N | X | judgment | Notes |
| 0.005 | ppt | 10 | 0 | 0 | 0 | 0 | 0 | |
| 0.02 | ppt | 10 | 0 | 0 | 0 | 0 | 0 | |
| 0.1 | ppt | 10 | 0 | 0 | 0 | 0 | 0 | |
| 0.2 | ppt | 8 | 2 | 0 | 0 | 0 | 0 | |
| 0.5 | ppt | 6 | 2 | 2 | 0 | 0 | 0 | |
| 1 | ppt | 0 | 6 | 3 | 1 | 0 | 0 | |
| 5 | ppt | 0 | 1 | 3 | 6 | 0 | 4 | 1 |
| 20 | ppt | 0 | 0 | 3 | 7 | 0 | 4 | 2 |
| 100 | ppt | 0 | 0 | 2 | 8 | 0 | 2 | 3 |
| 500 | ppt | 0 | 0 | 3 | 4 | 3 | 0 | 4 |
| 1 | ppb | 0 | 0 | 2 | 4 | 4 | 0 | 5 |
| 10 | ppb | 0 | 0 | 1 | 2 | 7 | 0 | 6 |
| 50 | ppb | 0 | 0 | 0 | 2 | 8 | 0 | 7 |

Evaluation
A: the number of panels who felt such that the acid taste/acid smell are extreme and cause irritation (there is no substantial difference from the case not containing the agent),
B: the number of panels who felt such that the acid taste/acid smell are slightly strong and slightly cause irritation (the acid taste/acid smell are slightly improved compared to the case not containing the agent),
C: the number of panels who felt such that the acid taste/acid smell are slightly unpleasant (the acid taste/acid smell are highly improved compared to the case not containing the agent),
N: the number of panels who felt such that the irritation of acid is reduced to give a mild acid taste,
X: the number of panels who felt such that though the acid taste is reduced, a piercing odor characteristic to aldehydes is unpleasant, and
Flavor judgment: the number of panels who judged that the acid taste/acid smell quality is the highest (comparison between concentrations).
1~3: Acid taste and smell are mild, and irritation is not particularly felt.
4: A piercing odor characteristic to aldehydes is very slightly felt.
5: A piercing odor characteristic to aldehydes is somewhat felt.
6: A piercing odor characteristic to aldehydes is moderately felt.
7: A piercing odor characteristic to aldehydes is somewhat strongly felt.

As shown in Table 7, though (E,Z,E)-2,4,7-tridecatrienal-free Vermont drink had extreme acid taste/acid smell to cause irritation, in the Vermont drink containing 0.2 ppt to 10 ppb of (E,Z,E)-2,4,7-tridecatrienal, an effect of reducing the acid taste/acid smell was observed, and the odor characteristic to (E,Z,E)-2,4,7-tridecatrienal was not so strong. The concentration range of the (E,Z,E)-2,4,7-tridecatrienal that relatively satisfactorily reduces the acid taste/acid smell and hardly causes the odor characteristic to (E,Z,E)-2,4,7-tridecatrienal was 1 ppt to 1 ppb. Furthermore, in a range of 5 ppt to 100 ppt, the odor characteristic to (E,Z,E)-2,4,7-tridecatrienal was not felt at all, and the evaluation of most panels was that the irritation of acid was reduced to give a mild acid taste.

### Example 8

### Reduction of Acid Taste/Acid Smell of Vermont Drink by (E,E,E)-2,4,7-Tridecatrienal

A drink was prepared as in Example 1 except that (E,E,E)-2,4,7-tridecatrienal was used instead of (Z,Z)-4,7-tridecadienal in Example 1 and was subjected to the same sensory evaluation. The results are shown in Table 8.

TABLE 8
Sensory evaluation of Vermont drink containing
(E,E,E)-2,4,7-tridecatrienal

| Concentration of (E,E,E)- | | | | | | | | |
|---|---|---|---|---|---|---|---|---|
| 2,4,7-tridecatrienal | | | | | | | | |
| (E,E,E)-2,4,7- | | Evaluation | | | | | Flavor | |
| tridecatrienal-free | | A | B | C | N | X | judgment | Notes |
| 0.005 | ppt | 10 | 0 | 0 | 0 | 0 | 0 | |
| 0.02 | ppt | 10 | 0 | 0 | 0 | 0 | 0 | |
| 0.1 | ppt | 10 | 0 | 0 | 0 | 0 | 0 | |
| 0.2 | ppt | 9 | 1 | 0 | 0 | 0 | 0 | |
| 0.5 | ppt | 7 | 1 | 2 | 0 | 0 | 0 | |
| 1 | ppt | 0 | 7 | 3 | 1 | 0 | 0 | |
| 5 | ppt | 0 | 2 | 3 | 5 | 0 | 2 | 1 |
| 20 | ppt | 0 | 1 | 3 | 6 | 0 | 5 | 2 |
| 100 | ppt | 0 | 2 | 2 | 6 | 0 | 3 | 3 |
| 500 | ppt | 0 | 0 | 4 | 4 | 2 | 0 | 4 |
| 1 | ppb | 0 | 0 | 2 | 4 | 4 | 0 | 5 |
| 10 | ppb | 0 | 0 | 2 | 2 | 6 | 0 | 6 |
| 50 | ppb | 0 | 0 | 0 | 3 | 7 | 0 | 7 |

Evaluation
A: the number of panels who felt such that the acid taste/acid smell are extreme and cause irritation (there is no substantial difference from the case not containing the agent),
B: the number of panels who felt such that the acid taste/acid smell are slightly strong and slightly cause irritation (the acid taste/acid smell are slightly improved compared to the case not containing the agent),
C: the number of panels who felt such that the acid taste/acid smell are slightly unpleasant (the acid taste/acid smell are highly improved compared to the case not containing the agent),
N: the number of panels who felt such that the irritation of acid is reduced to give a mild acid taste,
X: the number of panels who felt such that though the acid taste is reduced, a piercing odor characteristic to aldehydes is unpleasant, and
Flavor judgment: the number of panels who judged that the acid taste/acid smell quality is the highest (comparison between concentrations).
1~3: Acid taste and smell are mild, and irritation is not particularly felt.
4: A piercing odor characteristic to aldehydes is very slightly felt.
5: A piercing odor characteristic to aldehydes is somewhat felt.
6: A piercing odor characteristic to aldehydes is moderately felt.
7: A piercing odor characteristic to aldehydes is somewhat strongly felt.

As shown in Table 8, though (E,E,E)-2,4,7-tridecatrienal-free Vermont drink had extreme acid taste/acid smell to cause irritation, in the Vermont drink containing 0.2 ppt to 10 ppb of (E,E,E)-2,4,7-tridecatrienal, an effect of reducing the acid taste/acid smell was observed, and the odor characteristic to (E,E,E)-2,4,7-tridecatrienal was not so strong. The concentration range of the (E,E,E)-2,4,7-tridecatrienal that relatively satisfactorily reduces the acid taste/acid smell and hardly causes the odor characteristic to (E,E,E)-2,4,7-tridecatrienal was 1 ppt to 1 ppb. Furthermore, in a range of 5 ppt to 100 ppt, the odor characteristic to (E,E,E)-2,4,7-tridecatrienal was not felt at all, and the evaluation of most panels was that the irritation of acid was reduced to give a mild acid taste.

### Example 9

### Reduction of Acid Taste/Acid Smell of Yogurt by (Z,Z)-4,7-Tridecadienal

A yogurt base material as a control was prepared by mixing 100 parts by mass of commercially available plain yogurt (milk non-fat solids: 9.5%, milk fat component: 3.0%) with 0.1 parts by mass of acetic acid (glacial acetic acid: food additive, manufactured by Junsei Chemical Co., Ltd.) with stirring. To the resulting mixture was added (Z,Z)-4,7-tridecadienal as the acid taste and/or acid smell-reducing agent of the present invention in concentrations shown in the following Table 9 to give yogurt containing the agent, followed by sensory evaluation as in Example 1. The results are shown in Table 9.

TABLE 9
Sensory evaluation of yogurt containing (Z,Z)-4,7-tridecadienal

| Concentration of (Z,Z)- | | | | | | | | |
|---|---|---|---|---|---|---|---|---|
| 4,7-tridecadienal | | Evaluation | | | | | Flavor | |
| (Z,Z)-4,7-tridecadienal-free | | A | B | C | N | X | judgment | Notes |
| 0.005 | ppt | 10 | 0 | 0 | 0 | 0 | 0 | |
| 0.02 | ppt | 8 | 2 | 0 | 0 | 0 | 0 | |
| 0.1 | ppt | 5 | 3 | 2 | 0 | 0 | 0 | |
| 0.2 | ppt | 4 | 3 | 3 | 0 | 0 | 0 | |
| 0.5 | ppt | 1 | 1 | 2 | 6 | 0 | 1 | 1 |
| 1 | ppt | 0 | 1 | 3 | 6 | 0 | 2 | 2 |
| 5 | ppt | 0 | 0 | 2 | 8 | 0 | 4 | 3 |
| 20 | ppt | 0 | 0 | 4 | 6 | 0 | 3 | 4 |
| 100 | ppt | 0 | 1 | 3 | 4 | 2 | 0 | 5 |
| 500 | ppt | 0 | 0 | 3 | 4 | 3 | 0 | 6 |
| 1 | ppb | 0 | 0 | 3 | 3 | 4 | 0 | 7 |
| 10 | ppb | 0 | 0 | 2 | 2 | 6 | 0 | 8 |
| 50 | ppb | 0 | 0 | 1 | 1 | 8 | 0 | 9 |

Evaluation
A: the number of panels who felt such that the acid taste/acid smell are extreme and cause irritation (there is no substantial difference from the case not containing the agent),
B: the number of panels who felt such that the acid taste/acid smell are slightly strong and slightly cause irritation (the acid taste/acid smell are slightly improved compared to the case not containing the agent),
C: the number of panels who felt such that the acid taste/acid smell are slightly unpleasant (the acid taste/acid smell are highly improved compared to the case not containing the agent),
N: the number of panels who felt such that the irritation of acid is reduced to give a mild acid taste,
X: the number of panels who felt such that though the acid taste is reduced, a piercing odor characteristic to aldehydes is unpleasant, and
Flavor judgment: the number of panels who judged that the acid taste/acid smell quality is the highest (comparison between concentrations).
1~4: Acid taste and smell are mild, and irritation is not particularly felt.
5: A piercing odor characteristic to aldehydes is very slightly felt.
6: A piercing odor characteristic to aldehydes is slightly felt.
7: A piercing odor characteristic to aldehydes is somewhat felt.
8: A piercing odor characteristic to aldehydes is moderately felt.
9: A piercing odor characteristic to aldehydes is somewhat strongly felt.

As shown in Table 9, though (Z,Z)-4,7-tridecadienal-free yogurt had extreme acid taste/acid smell to cause irritation, in the yogurt containing 0.02 ppt to 10 ppb of (Z,Z)-4,7-tridecadienal, an effect of reducing the acid taste/acid smell was observed, and the odor characteristic to (Z,Z)-4,7-tridecadienal was not so strong. The concentration range of the (Z,Z)-4,7-tridecadienal that relatively satisfactorily reduces the acid taste/acid smell and hardly causes the odor characteristic to (Z,Z)-4,7-tridecadienal was 0.1 ppt to 500 ppt. Furthermore, in a range of 0.5 ppt to 20 ppt, the odor characteristic to (Z,Z)-4,7-tridecadienal was not felt at all, and the evaluation of most panels was that the irritation of acid was reduced to give a mild acid taste.

### Example 10

### Reduction of Acid Taste/Acid Smell of Dressing by (Z,Z)-4,7-Tridecadienal

A separation-type dressing base material (100 g) was prepared by mixing 20 g of edible vinegar, 35 g of vegetable oils and fats, and 45 g of an aqueous solution containing spices and extracts with stirring. To the resulting mixture was added (Z,Z)-4,7-tridecadienal as the acid taste and/or acid smell-reducing agent of the present invention in concentrations shown in the following Table 10 to give dressings containing the agent, followed by sensory evaluation as in Example 1. The results are shown in Table 10.

TABLE 10
Sensory evaluation of dressing containing (Z,Z)-4,7-tridecadienal

| Concentration of (Z,Z)- | | | | | | | | |
|---|---|---|---|---|---|---|---|---|
| 4,7-tridecadienal | | Evaluation | | | | | Flavor | |
| (Z,Z)-4,7-tridecadienal-free | | A | B | C | N | X | judgment | Notes |
| 0.005 | ppt | 10 | 0 | 0 | 0 | 0 | 0 | |
| 0.02 | ppt | 9 | 1 | 0 | 0 | 0 | 0 | |
| 0.1 | ppt | 6 | 4 | 0 | 0 | 0 | 0 | |
| 0.2 | ppt | 4 | 4 | 2 | 0 | 0 | 0 | |
| 0.5 | ppt | 1 | 2 | 2 | 5 | 0 | 1 | 1 |
| 1 | ppt | 0 | 1 | 3 | 6 | 0 | 1 | 2 |
| 5 | ppt | 0 | 0 | 3 | 7 | 0 | 4 | 3 |
| 20 | ppt | 0 | 0 | 3 | 7 | 0 | 4 | 4 |
| 100 | ppt | 0 | 1 | 3 | 4 | 2 | 0 | 5 |
| 500 | ppt | 0 | 0 | 4 | 4 | 2 | 0 | 6 |
| 1 | ppb | 0 | 0 | 3 | 3 | 4 | 0 | 7 |
| 10 | ppb | 0 | 0 | 1 | 2 | 7 | 0 | 8 |
| 50 | ppb | 0 | 0 | 0 | 2 | 8 | 0 | 9 |

Evaluation
A: the number of panels who felt such that the acid taste/acid smell are extreme and cause irritation (there is no substantial difference from the case not containing the agent),
B: the number of panels who felt such that the acid taste/acid smell are slightly strong and slightly cause irritation (the acid taste/acid smell are slightly improved compared to the case not containing the agent),
C: the number of panels who felt such that the acid taste/acid smell are slightly unpleasant (the acid taste/acid smell are highly improved compared to the case not containing the agent),
N: the number of panels who felt such that the irritation of acid is reduced to give a mild acid taste,
X: the number of panels who felt such that though the acid taste is reduced, a piercing odor characteristic to aldehydes is unpleasant, and
Flavor judgment: the number of panels who judged that the acid taste/acid smell quality is the highest (comparison between concentrations).
1~4: Acid taste and smell are mild, and irritation is not particularly felt.
5: A piercing odor characteristic to aldehydes is very slightly felt.
6: A piercing odor characteristic to aldehydes is slightly felt.
7: A piercing odor characteristic to aldehydes is somewhat felt.
8: A piercing odor characteristic to aldehydes is moderately felt.
9: A piercing odor characteristic to aldehydes is somewhat strongly felt.

As shown in Table 10, though (Z,Z)-4,7-tridecadienal-free dressing had extreme acid taste/acid smell to cause irritation, in the dressing containing 0.02 ppt to 10 ppb of (Z,Z)-4,7-tridecadienal, an effect of reducing the acid taste/acid smell was observed, and the odor characteristic to (Z,Z)-4,7-tridecadienal was not so strong. The concentration range of the (Z,Z)-4,7-tridecadienal that relatively satisfactorily reduces the acid taste/acid smell and hardly causes the odor characteristic to (Z,Z)-4,7-tridecadienal was 0.1 ppt to 500 ppt. Furthermore, in a range of 0.5 ppt to 20 ppt, the odor characteristic to (Z,Z)-4,7-tridecadienal was not felt at all, and the evaluation of most panels was that the irritation of acid was reduced to give a mild acid taste.

### Example 11

### Reduction of Acid Taste/Acid Smell of Mayonnaise by (Z,Z)-4,7-Tridecadienal

A mayonnaise base material (100 g) was prepared by mixing 12 g of edible vinegar, 75 g of vegetable oils and fats, and 13 g of an aqueous solution containing egg yolk and spices. To the resulting mixture was added (Z,Z)-4,7-tridecadienal as the acid taste and/or acid smell-reducing agent of the present invention in concentrations shown in the following Table 11 to give mayonnaise containing the agent, followed by sensory evaluation as in Example 1. The results are shown in Table 11.

TABLE 11
Sensory evaluation of mayonnaise containing (Z,Z)-4,7-tridecadienal

| Concentration of (Z,Z)- | | | | | | | | |
|---|---|---|---|---|---|---|---|---|
| 4,7-tridecadienal | | Evaluation | | | | | Flavor | |
| (Z,Z)-4,7-tridecadienal-free | | A | B | C | N | X | judgment | Notes |
| 0.005 | ppt | 10 | 0 | 0 | 0 | 0 | 0 | |
| 0.02 | ppt | 8 | 2 | 0 | 0 | 0 | 0 | |
| 0.1 | ppt | 7 | 2 | 1 | 0 | 0 | 0 | |
| 0.2 | ppt | 3 | 4 | 3 | 0 | 0 | 0 | |
| 0.5 | ppt | 0 | 2 | 3 | 5 | 0 | 1 | 1 |
| 1 | ppt | 0 | 2 | 2 | 6 | 0 | 1 | 2 |
| 5 | ppt | 0 | 0 | 2 | 8 | 0 | 4 | 3 |
| 20 | ppt | 0 | 0 | 3 | 7 | 0 | 4 | 4 |
| 100 | ppt | 0 | 1 | 4 | 4 | 1 | 0 | 5 |
| 500 | ppt | 0 | 0 | 4 | 4 | 2 | 0 | 6 |
| 1 | ppb | 0 | 0 | 2 | 4 | 4 | 0 | 7 |
| 10 | ppb | 0 | 0 | 1 | 2 | 7 | 0 | 8 |
| 50 | ppb | 0 | 0 | 1 | 1 | 8 | 0 | 9 |

Evaluation
A: the number of panels who felt such that the acid taste/acid smell are extreme and cause irritation (there is no substantial difference from the case not containing the agent),
B: the number of panels who felt such that the acid taste/acid smell are slightly strong and slightly cause irritation (the acid taste/acid smell are slightly improved compared to the case not containing the agent),
C: the number of panels who felt such that the acid taste/acid smell are slightly unpleasant (the acid taste/acid smell are highly improved compared to the case not containing the agent),
N: the number of panels who felt such that the irritation of acid is reduced to give a mild acid taste,
X: the number of panels who felt such that though the acid taste is reduced, a piercing odor characteristic to aldehydes is unpleasant, and
Flavor judgment: the number of panels who judged that the acid taste/acid smell quality is the highest (comparison between concentrations).
1~4: Acid taste and smell are mild, and irritation is not particularly felt.
5: A piercing odor characteristic to aldehydes is very slightly felt.
6: A piercing odor characteristic to aldehydes is slightly felt.
7: A piercing odor characteristic to aldehydes is somewhat felt.
8: A piercing odor characteristic to aldehydes is moderately felt.
9: A piercing odor characteristic to aldehydes is somewhat strongly felt.

As shown in Table 11, though (Z,Z)-4,7-tridecadienal-free mayonnaise had extreme acid taste/acid smell to cause irritation, in the mayonnaise containing 0.02 ppt to 10 ppb of (Z,Z)-4,7-tridecadienal, an effect of reducing the acid taste/acid smell was observed, and the odor characteristic to (Z,Z)-4,7-tridecadienal was not so strong. The concentration range of the (Z,Z)-4,7-tridecadienal that relatively satisfactorily reduces the acid taste/acid smell and hardly causes the odor characteristic to (Z,Z)-4,7-tridecadienal was 0.1 ppt to 500 ppt. Furthermore, in a range of 0.5 ppt to 20 ppt, the odor characteristic to (Z,Z)-4,7-tridecadienal was not felt at all, and the evaluation of most panels was that the irritation of acid was reduced to give a mild acid taste.

### Example 12

### Reduction of Acid Taste/Acid Smell of Orange Juice by (Z,Z)-4,7-Tridecadienal

To commercially available 100% orange juice was added (Z,Z)-4,7-tridecadienal as the acid taste and/or acid smell-reducing agent of the present invention in concentrations shown in the following Table 12 to give orange juice containing the agent, followed by sensory evaluation as in Example 1. The results are shown in Table 12.

TABLE 12
Sensory evaluation of orange juice containing (Z,Z)-4,7-tridecadienal

| Concentration of (Z,Z)-4,7- | | | | | | | | |
|---|---|---|---|---|---|---|---|---|
| tridecadienal | | Evaluation | | | | | Flavor | |
| (Z,Z)-4,7-tridecadienal-free | | A | B | C | N | X | judgment | Notes |
| 0.005 | ppt | 10 | 0 | 0 | 0 | 0 | 0 | |
| 0.02 | ppt | 9 | 1 | 0 | 0 | 0 | 0 | |
| 0.1 | ppt | 8 | 1 | 1 | 0 | 0 | 0 | |
| 0.2 | ppt | 6 | 2 | 2 | 0 | 0 | 0 | |
| 0.5 | ppt | 0 | 2 | 2 | 6 | 0 | 1 | 1 |
| 1 | ppt | 0 | 2 | 2 | 6 | 0 | 1 | 2 |
| 5 | ppt | 0 | 1 | 2 | 7 | 0 | 4 | 3 |
| 20 | ppt | 0 | 0 | 3 | 7 | 0 | 4 | 4 |
| 100 | ppt | 0 | 0 | 4 | 4 | 2 | 0 | 5 |
| 500 | ppt | 0 | 0 | 3 | 4 | 3 | 0 | 6 |
| 1 | ppb | 0 | 0 | 2 | 4 | 4 | 0 | 7 |
| 10 | ppb | 0 | 0 | 1 | 3 | 6 | 0 | 8 |
| 50 | ppb | 0 | 0 | 1 | 2 | 7 | 0 | 9 |

Evaluation
A: the number of panels who felt such that the acid taste/acid smell are extreme and cause irritation (there is no substantial difference from the case not containing the agent),
B: the number of panels who felt such that the acid taste/acid smell are slightly strong and slightly cause irritation (the acid taste/acid smell are slightly improved compared to the case not containing the agent),
C: the number of panels who felt such that the acid taste/acid smell are slightly unpleasant (the acid taste/acid smell are highly improved compared to the case not containing the agent),
N: the number of panels who felt such that the irritation of acid is reduced to give a mild acid taste,
X: the number of panels who felt such that though the acid taste is reduced, a piercing odor characteristic to aldehydes is unpleasant, and
Flavor judgment: the number of panels who judged that the acid taste/acid smell quality is the highest (comparison between concentrations).
1~4: Acid taste and smell are mild, and irritation is not particularly felt.
5: A piercing odor characteristic to aldehydes is very slightly felt.
6: A piercing odor characteristic to aldehydes is slightly felt.
7: A piercing odor characteristic to aldehydes is somewhat felt.
8: A piercing odor characteristic to aldehydes is moderately felt.
9: A piercing odor characteristic to aldehydes is somewhat strongly felt.

As shown in Table 12, though (Z,Z)-4,7-tridecadienal-free orange juice had extreme acid taste/acid smell to cause irritation, in the orange juice containing 0.02 ppt to 10 ppb of (Z,Z)-4,7-tridecadienal, an effect of reducing the acid taste/acid smell was observed, and the odor characteristic to (Z,Z)-4,7-tridecadienal was not so strong. The concentration range of the (Z,Z)-4,7-tridecadienal that relatively satisfactorily reduces the acid taste/acid smell and hardly causes the odor characteristic to (Z,Z)-4,7-tridecadienal was 0.1 ppt to 500 ppt. Furthermore, in a range of 0.5 ppt to 20 ppt, the odor characteristic to (Z,Z)-4,7-tridecadienal was not felt at all, and the evaluation of most panels was that the irritation of acid was reduced to give a mild acid taste.

1. An agent for reducing acid taste and/or acid smell of a food or drink, the agent comprising one of (Z,Z)-, (E,Z)-, (Z,E)-, and (E,E)-4,7-tridecadienals.

2. An agent for reducing acid taste and/or acid smell of a food or drink, the agent comprising one of (E,Z,Z)-, (E,Z,E)-, (E,E,Z)-, and (E,E,E)-2,4,7-tridecatrienals.

3. An acid taste and/or acid smell-reducing agent composition containing 0.02 ppb to 10 ppm of an agent for reducing acid taste and/or acid smell according to claim 1.

4. A method of reducing acid taste and/or acid smell, the method comprising adding an agent for reducing acid taste and/or acid smell according to claim 1 to a food or drink having acid taste and/or acid smell in an amount of 0.02 ppt to 10 ppb.

5. A food or drink (excluding foods and drinks having dried fish-like aroma/flavor) having reduced acid taste and/or acid smell, wherein the food or drink contains 0.02 ppt to 10 ppb of an agent for reducing acid taste and/or acid smell according to claim 1.
